(19) United States
(12) Patent Application Publication
(10) Pub. No.: US 2004/0031548 A1
(43) Pub. Date: Feb. 19, 2004

(54) Method for improving the grip of a tyre on a snowy and/or icy road, and a winter tyre

(76) Inventors: Angela Amaddeo, Arienzo (IT); Luciano Garro, Ornago (IT)

Correspondence Address: Finnegan Henderson Farabow, Garrett & Dunner, 1300 I Street NW, Washington, DC, 20005, US

(21) Appl. No.: 10/415,333

(22) PCT Filed: Oct. 23, 2001
(86) PCT No.: PCT/EP01/12225

(30) Foreign Application Priority Data
Oct. 30, 2000 (EP) 00123640.5

(51) Int. Cl. B60C 11/00

(52) U.S. Cl. 152/209.1

(57) ABSTRACT

A method for improving tyre grip on snowy and/or icy roads includes forming a tread band with a base elastomeric material comprising at least 70 wt % of a polymer mixture including between 20 wt % and 60 wt % of at least one styrene/1,3-butadiene copolymer and between 40 wt % and 80 wt % of at least one 1,3-butadiene homopolymer. The at least one styrene/1,3-butadiene copolymer comprises styrene units and vinyl units. The at least one 1,3-butadiene homopolymer comprises vinyl units. The glass transition temperature of the at least one styrene/1,3-butadiene copolymer is at least 30° C. higher than that of the at least one 1,3-butadiene homopolymer. A mixture of the at least one styrene/1,3-butadiene copolymer with the at least one 1,3-butadiene homopolymer shows a single glass transition peak having a maximum value corresponding to a temperature greater than or equal to −70° C. and less than or equal to −45° C.

The present invention relates to a method for improving the road grip of a tyre on a snowy and/or icy road and to a winter tyre; in particular, the method of the invention enables a tyre to be obtained having good road grip, especially on ice and on snowy ground.

Among tyre manufacturers there is a deeply felt requirement to provide customers with tires of winter type, i.e. tyres which, without using snow studs or other mechanical expedients, are able to ensure good road grip, even in the presence of extreme atmospheric and ground conditions, in particular very low temperatures on icy and/or snowy ground. Such performance must not however influence the other properties commonly required of a tyre, such as high wear and tear resistance, good grip on a dry or wet road, and low resistance to rolling.

It is a common opinion among practitioners of the art that an elastomeric material suitable for forming the tread band of a winter tyre must have the lowest possible glass transition temperature (Tg), in order to reduce the hardening phenomena typical of elastomers when subjected to low temperatures.

Elastomers potentially suitable for this purpose are natural rubber (NR), having a Tg generally around −60° C., and cis-1,4-polybutadiene (BR), having a Tg generally around −90° C. [see for example the article by S. Futamura in “Rubber Chemistry and Technology”,Vol. 69, pp. 648-653 (1996)].

In order to increase the tyre traction on ice and/or snow, it is also known to add to the constituent elastomeric material of the tread band various products able to create microstuds and/or micropores on the tread surface.

For example, JP-A-62-283001 suggests the use, for the tread band, of an elastomeric composition based on a polymer of low Tg (lower than −60° C.) suitably expanded with closed cells of average diameter from 1 to 120 μm. The resultant tyre is stated to have improved traction on ice and snow. To improve abrasion resistance, it has also been suggested to add a fibrous material to the expanded elastomeric material (see for example JP-A-63-089547).

Likewise, JP-A-H5-170976 describes a tyre having improved grip on snowy or icy ground, in which the tread band includes short fibres and from 1 to 15 phr (phr=parts per hundred rubber, i.e. parts by weight per 100 parts by weight of polymer base material) of powdered polyvinylalcohol. The fibres, based for example on cellulose or synthetic polymers, are orientated along the circumferential direction of the tyre to confer anisotropic characteristics. The grip on icy or snowy surfaces is improved by the presence of the polyvinylalcohol particles which, when coming into contact with water, dissolve to leave cavities in the tread which improve its roughness and hence grip.

U.S. Pat. No. 4,427,832 describes polymer compositions suitable for forming tyres having superior traction on ice, in which the base polymer is added with powder of a polymer which increases its hardness at low temperatures and becomes soft at high temperatures. This polymer can be crosslinked, or can be non-crosslinked, but is of high molecular weight, for example polynorbornene or a styrene/butadiene copolymer (SBR).

In other cases it has been proposed to use particular elastomeric polymers as materials for forming the tread band.

For example, to give a tyre good road grip on both dry and wet or icy ground, without compromising its life and tear resistance, EP-A-585,012 describes the use for the tread band of a composition comprising at least 30 wt % of a mixture of 100 parts by weight of a branched SBR copolymer and from 15 to 100 parts by weight of a low molecular weight butadiene polymer. The branched SBR copolymer contains from 15 to 50 wt % of styrene units, from 20 to 70 wt % of vinyl units, has a mean molecular weight from 600,000 to 3,000,000, and is coupled by a coupling agent having 2-6 functionalities. The butadiene polymer has a styrene content from 0 to 60 wt %, a vinyl content from 20 to 70 wt %, a Tg not lower than −45° C., and a mean molecular weight from 2,000 to 50,000.

To produce a tyre having good road grip on a wet surface and on ice while at the same time having a low resistance to rolling, patent application GB 2,158,076 describes the use of a polymer composition comprising at least 20% of a styrene-butadiene block copolymer, consisting of: an SBR-based first block (A) containing from 10 to 80 wt % of styrene and from 30 to 70 wt % of vinyl groups deriving from the butadiene units; a BR-based second block (B) containing from 30 to 70 wt % of vinyl groups. The total quantity of styrene in the block copolymer is between 5 and 40 wt %. Each block is present in a quantity of at least 20 wt %. The content of vinyl groups in block (A) is higher than that in block (B) by at least 5 wt %. The Tg of block (A) is higher than the Tg of block (B) by at least 30° C. At least 20 wt % of the block copolymer is a branched block copolymer coupled by a coupling agent having 3-4 functionalities. The extent of distribution of the content of vinyl groups in each block is at least 10%.

The Applicant considered the technical problem of producing a winter tyre ensuring excellent grip on an icy and/or snowy road, while having a good performance balance on both wet and dry ground, even in the presence of extreme atmospheric and ground conditions and without it being necessary to use snow studs or other mechanical expedients which modify the tread ground contact surface in order to increase its traction on ice.

The Applicant has unexpectedly found that said technical problem can be solved by a method for improving the grip of a tyre on a snowy and/or icy road, which comprises forming the relative tread band with a base elastomeric material comprising a mixture of an SBR polymer and a BR polymer as hereinafter defined.

According to a first aspect, the invention concerns a method for improving the grip of a tyre (1) on a snowy and/or icy road, said tyre comprising a belt structure (12) extending coaxially about a carcass structure (2), and a tread band (9) extending coaxially about the belt structure (12) and presenting a rolling surface (9a) arranged to enter into contact with the ground, which comprises forming said tread band with a base elastomeric material comprising at least 70 wt %, preferably at least 80 wt %, on the total weight of the elastomeric components, of a polymer mixture comprising:

(A) from 20 to 60 wt % of at least one styrene/1,3-butadiene copolymer having a content of styrene units from 10 to 25 wt %, and a content of vinyl units from 40 to 80 wt %; and

(B) from 40 to 80 wt % of at least one 1,3-butadiene homopolymer having a content of vinyl units lower than or equal to 15 wt %;

the quantities of (A) and (B) being expressed on the total weight of the polymer mixture;

wherein:

the copolymer (A) has a glass transition temperature (Tg) higher by at least 30° C. than the Tg of the homopolymer (B), and wherein

the mixture of the copolymer (A) with the homopolymer (B) shows a single glass transition peak having a maximum between −70° C. and −45° C.

According to a further aspect, the invention concerns a winter tyre (1) comprising a belt structure (12) extending cordally about a carcass structure (2), and a tread band (9) extending coaxially about the belt structure (12) and presenting a rolling surface (9a) arranged to enter into contact with the ground, wherein said tread band comprises a base elastomeric material comprising at least 70 wt %, preferably at least 80 wt %, on the total weight of the elastomeric components, of a polymer mixture comprising:

(A) from 20 to 60 wt % of at least one styrene/1,3-butadiene copolymer having a content of styrene units from 10 to 25 wt %, and a content of vinyl units from 40 to 80 wt %; and

(B) from 40 to 80 wt % of at least one 1,3-butadiene homopolymer having a content of vinyl units lower than or equal to 15 wt %;

the quantities of (A) and (B) being expressed on the total weight of the polymer mixture;

wherein:

the copolymer (A) has a glass transition temperature (Tg) higher by at least 30° C., preferably by at least 40° C., than the Tg of the homopolymer (B).

Preferably, the copolymer (A) has a content of styrene units from 12 to 20 wt % and a content of vinyl units from 45 to 70 wt %.

Preferably, the homopolymer (B) (also indicated as “polybutadiene” or “1,4-polybutadiene”) has a content of vinyl units from 0.2 to 11 wt %, more preferably from 0.5 to 4 wt %, the content of 1,4-cis units being from 92 to 99 wt %.

Preferably, the Tg of the copolymer (A) is lower than or equal to −10° C., more preferably from −50° C. to −30° C., the Tg of the homopolymer (B) being lower than or equal to −80° C., more preferably from −90° C. to −105° C.

The Applicant has also observed that the superior performance of the tyre of the invention could be attributed, inter alia, also to the substantial mutual solubility between the copolymer (A) and homopolymer (B) as hereinbefore defined. This substantial solubility is demonstrated by the presence of a single glass transition peak for the mixture of (A) and (B). The position and variation of the glass transition in the polymer material of the invention can be evaluated by known methods, for example by differential scanning calorimetry (DSC), or preferably by measuring the tangent of the dissipation angle (tandelta) against temperature, as described in detail hereinafter.

The mixture of the copolymer (A) with the homopolymer (B) shows a single glass transition peak having a maximum between −70° C. and −45° C., preferably between −65° C. and −55° C.

Preferably, the copolymer (A) and the homopolymer (B) are present in the mixture in a quantity from 25 to 50 wt % and from 50 to 75 wt %, respectively, on the total mixture weight.

In the present description, the polymer component quantities are expressed on a dry component basis, i.e. without the extension oil commonly used in many commercial products.

The Applicant has found that the tyre of the invention enables a good road grip to be obtained on ice and/or on snowy ground, even if extreme atmospheric and ground conditions are present, while maintaining a good performance balance both on wet ground and on dry ground.

This result is achieved without using block polymers, such as those described for example in GB-2,158,076, but simply by mixing the copolymer (A) and the homopolymer (B) together by conventional methods commonly used for producing mixtures (for example by an internal mixer of Banbury type, or by continuous mixers, for example double-screw extruders).

The copolymers (A) used according to the invention are of the so-called “high vinyl” type, in which 1,3-butadiene polymerizes with styrene prevalently in 1,2 form, to provide on the copolymer a quantity of —CH═CH₂ vinyl units of between 40 wt % and 80 wt % on the total polymer weight.

According to the invention, the base elastomeric material used for implementing the invention can further comprise at least one elastomeric polymer (C), different from (A) and (B), in a quantity lower than or equal to 30 wt %, preferably lower than or equal to 20 wt % on the total weight of the polymer material.

This elastomeric polymer (C) can be selected, for example, from: natural rubber, polybutadiene, polyisoprene, polychloroprene, polynorbornene, isoprene-isobutene copolymers, possibly halogenated, butadiene-acrylonitrile copolymers, styrene-butadiene-isoprene terpolymers and ethylene-propylenediene terpolymers.

Preferably, the polymer (C) is natural rubber.

According to a further preferred aspect of the invention, the aforedescribed base elastomeric material comprises at least one reinforcing filler, the total quantity of which can vary in general from 50 to 100 phr. The reinforcing filler can be selected from those commonly used in the sector and, for example and preferably, comprises at least one of the following products: carbon black, alumina, silica, silico-aluminates, calcium carbonate, kaolin and the like or their mixtures.

According to another preferred aspect, the reinforcing filler comprises silica in a quantity from 50 to 100 phr, preferably from 60 to 70 phr. Carbon black can be added as additional filler to the reinforcing fiber comprising silica. The quantity of carbon black can vary from 5 to 40 phr, preferably from 15 to 30 phr.

According to the invention, if the reinforcing filler comprises silica, the elastomeric composition used for manufacturing the tread band of the tyre of the invention can further incorporate at least one coupling agent able to interact with the silica and bind this latter to the base polymer material during its vulcanization.

Coupling agents of preferred use are those of the silane type, identifiable for example by the following structural formula:

(R)₃Si—CₙH₂ₙ—X

where:

the R groups, equal or different, are selected from: allkyl, alkoxy or aryloxy groups or halogen atoms, with the proviso that at least one of the R groups is an alkoxy or aryloxy group;

n is a whole number between 1 and 6;

X is a group selected from nitroso, mercapto, amino, epoxy, vinyl, imido, chloro, —(S)ₘ—CₙH₂ₙ—Si(R)₃, in which m is a whole number between 1 and 6 and

n and the R groups are defined as above.

Of these, particularly preferred is bis(3-triethoxysilylpropyl)tetrasulphide (Si69).

The silica usable according to the present invention can be for example a pyrogenic silica or, preferably, a precipitated silica, having a BET surface area (measured in accordance with ISO 5794/1) generally between 50 and 300 m²/g, preferably between 90 and 200 m²/g.

The types of carbon black used conventionally in the sector and utilizable for implementing the invention comprise those designated on an ASTM basis by the codes N110, N121, N220, N231, N234, N236, N239, N242, N299, N315, N330, N332, N339, N347, N351, N358, N375.

Preferably, the reinforcing filler based on carbon black has a DBP absorption value (measured in accordance with ISO 4656-1) of at least 80 ml/100 g and a surface area (measured by CTAB absorption in accordance with ISO 6810) not lower than 50 m²/g, preferably between 80 and 120 m²/g.

The mixtures usable according to the invention are made vulcanizable by adding and incorporating a suitable vulcanizing agent, possibly and preferably with the addition of vulcanization activating and accelerating agents well known to the practitioners of the art.

The preferred vulcanizing agent is sulphur, or sulphur-containing molecules (sulphur donors).

Particularly effective activating agents are zinc compounds and in particular ZnO, ZnCO₃, zinc salts of saturated or unsaturated C₈-C₁₈ fatty acids, such as zinc stearate, preferably formed in situ in the mixture starting from ZnO and fatty acid, and BiO, PbO, Pb₃O₄, PbO₂ and their mixtures.

Commonly used accelerators can be selected from: dithiocarbainates, guanidines, thioureas, thiazoles, sulphenamides, thiourams, amunes, xanthates and the like, or their mixtures.

Other ingredients which can be incorporated into the described mixtures are those, commonly used in the sector, which are needed to give the mixtures the required mechanical and processing characteristics, such as: plasticizers, processing aids, antioxidants, anti-ageing agents, etc.

Further particulars are illustrated from the following detailed description, with reference to the accompanying drawings, in which:

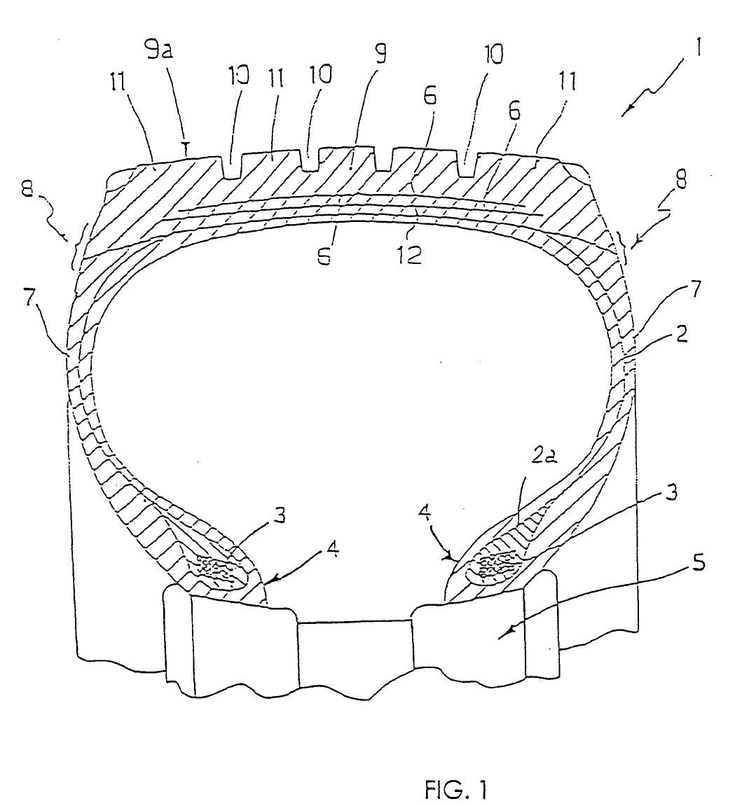

FIG. 1 is a section through a tyre of the present invention;

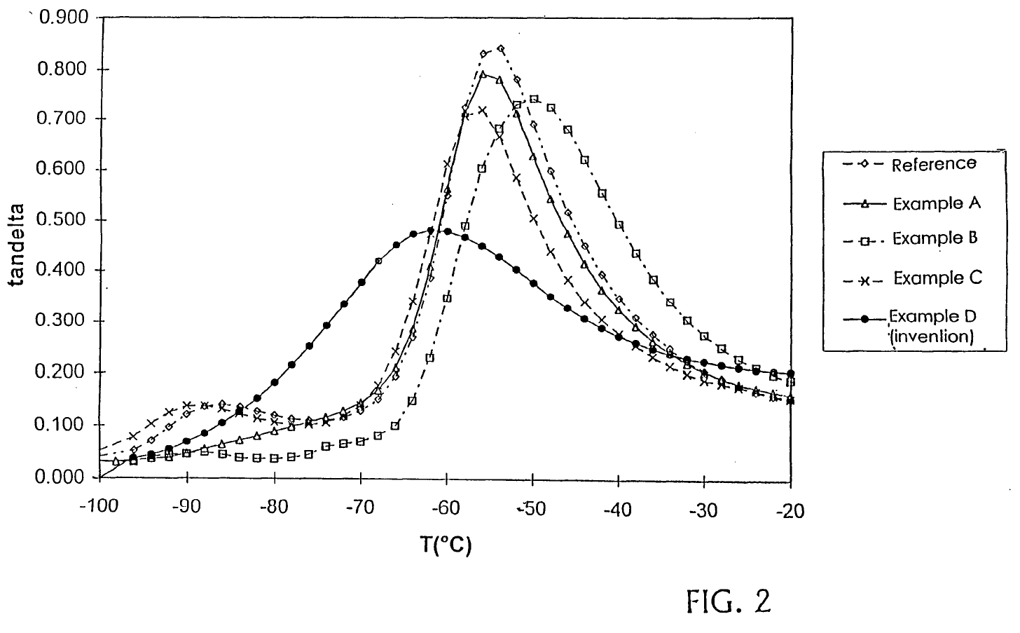

FIG. 2 shows the variation in tandelta with varying temperature for five different tread mixtures.

In FIG. 1, the tyre comprises, conventionally, at least one carcass ply 2, the opposing lateral edges of which are coupled to respective fixing bead wires 3. Each bead wire 3 is incorporated into a bead 4, defined along an inner circumferential edge of the tyre, in correspondence with which the tyre engages a rim 5 forming part of a vehicle wheel.

The connection between the carcass ply 2 and the bead wires 3 is usually made by folding the opposing lateral edges of the carcass ply 2 about the bead wires 3, to form the so-called carcass turn-ups 2a as shown in FIG. 1.

Alternatively, the conventional bead wires 3 can be replaced by a pair of circumferentially inextensible annular inserts formed from elongate elements disposed in concentric turns (not shown in FIG. 1) (see for example EP-A-0 928 680 and EP-A-0 928 702). In this case, the carcass ply 2 is not turned about said annular inserts, the connection being ensured by a second carcass ply (not shown in FIG. 1) applied to the outside of the first.

Along the circumferential extension of the carcass ply 2, there is applied a belt structure 12, comprising one or more strips 6 formed from textile or metal cords incorporated into a rubber sheet.

On the outside of the carcass ply 2, in respective opposing lateral portions thereof, there is also applied a pair of sidewalls 7, each of which extends from the bead 4 to a so-called “shoulder” region 8 of the tyre, defined at the opposing ends of the belt structure 12. On the belt structure 12, there is circumferentially applied a tread band 9, the lateral edges of which terminate at the shoulders 8, to join with the sidewalls 7. The tread band 9 externally presents a rolling surface 9a intended to make contact with the ground, and in which circumferential grooves 10 can be provided, cut by transverse cuts, not visible in FIG. 1, which define a plurality of blocks 11 variously distributed on said rolling surface 9a.

The tyre of the present invention can be produced by any procedure known in the art, including at least one crude tyre formation stage and at least one vulcanization stage thereof.

More particularly, the formation stage comprises separate preliminary steps of preparing a series of semi-finished parts corresponding to the different parts of the tyre (carcass plies, belt strips, bead wires, bead, fillings, side walls and tread bands), which are then associated with each other by suitable assembly machines.

Alternative processes for producing a tyre or components thereof without using semi-finished parts are described, for example, in the aforesaid EP-A-0 928 680 and EP-A-0 928 702.

The subsequent vulcanization stage comprises bonding together the aforesaid semi-finished parts to produce a monolithic block, i.e. the finished tyre.

The preparation stage for said semi-finished parts is naturally preceded by a stage in which the relative mixtures are prepared and moulded by conventional methods. In particular, the tread band 9 of the tyre of the invention is prepared by moulding a mixture of the aforedescribed type.

The following examples illustrate the invention without limiting it.

### EXAMPLES

Five different tread mixtures were prepared, the compositions of which are given in Table 1. All the quantities are expressed in phr, the values referring to the dry polymers.

The main characteristics of the mixtures, vulcanized by heating at 151° C. for 30 min, are given in Table 2. The hardness (in degrees IRHD) was measured in accordance with standard ISO 48, the tensile properties with standard ISO 37.

Table 2 also shows the dynamic elastic properties, measured by a dynamic Instron device in traction-compression in the following manner.

A testpiece of crosslinked material of cylindrical shape (length=25 mm; diameter=14 nm), preloaded by compression to a longitudinal deformation of 10% on the initial length, and maintained at the predetermined temperature for the entire test duration, was subjected to dynamic sinusoidal deformation of amplitude ±3.33% on the length under preload, with a frequency of 100 Hz. The dynamic elastic properties are expressed in terms of dynamic elastic modulus (E′), viscous modulus (E″) and tandelta (loss factor), calculated as E″/E′.

TABLE 1

| | | Example | Example | Example | Example |
|---|---|---|---|---|---|
| | Reference | A (cfr.) | B (cfr.) | C (cfr) | D |
| NR | 50 | 50 | 50 | 45 | — |
| EUROPRENE | 68.75 | 34 | — | 75 | 50 |
| NEOCIS ® OE | | | | | |
| BUNA ® SL25-1 | — | 35 | 68.75 | — | — |
| BUNA ® VSL 4515-1 | — | — | — | — | 68.75 |
| DUTREX ® 80 | 30 | 30 | 30 | 28 | 30 |
| Silica | 70 | 70 | 70 | 70 | 70 |
| Si69 | 5.6 | 5.6 | 5.6 | 5.6 | 5.6 |
| Accelerators | 2.2 | 2.2 | 2.2 | 2.2 | 2.2 |
| Sulphur | 1.6 | 1.6 | 1.6 | 1.6 | 1.6 |

- cfr. = comparison

NR=natural rubber

EUROPRENE NEOCIS® O.E. (Enichem)=cis-1,4-polybutadiene (containing 37.5 phr of aromatic oils), having a content of vinyl units of 0.8 wt % and a content of 1,4-cis units of 98.3 wt %, Tg=−98° C.

BUNA® SL 25-1 (Bayer)=styrene/1,3-butadiene copolymer (containing 37.5 phr of aromatic oil), having 25% of styrene units and 13% of vinyl units, Tg=−60° C.;

BUNA® VSL 4515-1 (Bayer)=styrene/1,3-butadiene copolymer (containing 37.5 phr of aromatic oil), having 15% of styrene units and 53% of vinyl units, Tg=−42° C.;

DUTREX® 80 (Shell)=plasticizing oil with high aromaticity index;

Si69 (Degussa)=bis(3-triethoxysilyl-propyl)tetrasulphide;

Accelerators=mixture of DPG (diphenylguadinine-Monsanto) and SANTOCURE® CBS (N-cyclohexyl-2-benzothiazyl-sulphenammide-Monsanto);

Silica=ZEOSIL®D 1115 MP having a BET surface area of 100 m²/g (Rhöne Poulenc).

TABLE 2

| | | Example | Example | Example | Example |
|---|---|---|---|---|---|
| | Reference | A (cfr.) | B (cfr) | C (cfr.) | D |
| Hardness IRHD | | | | | |
| −10° C. | 60.8 | 60.3 | 60.1 | 60.3 | 60.8 |
| 0° C. | 58.6 | 59.8 | 58.9 | 59.3 | 59.7 |
| 23° C. | 54.6 | 51.8 | 56.5 | 58.1 | 59.0 |
| Stress at 100% (MPa) | 1.1 | 1.3 | 1.2 | 1.2 | 1.1 |
| Stress at 300% (MPa) | 4.0 | 5.2 | 5.0 | 4.4 | 3.8 |
| Stress at break (MPa) | 11.3 | 11.3 | 11.0 | 11.2 | 11.4 |
| Elongation at break (%) | 645.2 | 600.0 | 594.8 | 649.8 | 537.4 |
| E′ (MPa) | | | | | |
| −10° C. | 6.4 | 5.9 | 6.6 | 5.0 | 5.9 |
| 0° C. | 5.5 | 5.1 | 5.4 | 4.4 | 5.4 |
| 23° C. | 4.4 | 4.3 | 4.3 | 3.8 | 4.6 |
| E″ (MPa) | | | | | |
| −10° C. | 2.6 | 2.2 | 3.0 | 1.6 | 1.9 |
| 0° C. | 1.9 | 1.4 | 1.8 | 1.1 | 1.4 |
| 23° C. | 1.1 | 0.8 | 0.9 | 0.6 | 0.9 |
| Tandelta | | | | | |
| −10° C. | 0.400 | 0.364 | 0.457 | 0.316 | 0.320 |
| 0° C. | 0.332 | 0.283 | 0.334 | 0.254 | 0.266 |
| 23° C. | 0.251 | 0.190 | 0.200 | 0.166 | 0.192 |

FIG. 2 shows the curves of tandelta for the different mixtures as a function of temperature, measured within a range from −20° C. to −100° C.

The tests were carried out on testpieces in the form of strips of width 12.0±0.2 mm, thickness of 2.0±0.2 mm and length of 40.0±0.2 mm (useful length 24 mm) subjected to torsion with an amplitude of 0.1% and frequency of 1 Hz by a rheometer of Rheometrics, Model “Rheometer R.D.A. 700”.

Table 3 shows the values of the tandelta(max)/T(max) pairs corresponding to the maximum values recorded by the instrument within the range from −100° C. to −20° C.

TABLE 3

| | | Example | Example | Example | Example |
|---|---|---|---|---|---|
| | Reference | A (cfr.) | B (cfr) | C (cfr.) | D |
| Tandelta | 0.841 | 0.790 | 0.739 | 0.716 | 0.480 |
| (max) | | | | | |
| T(max) | −53 | −55 | −50 | −56 | −62 |
| (° C.) | | | | | |

As can be seen from FIG. 2 and Table 3, the composition D of the invention has a single peak the maximum of which is centered around −62° C. corresponding to the Tg of the elastomeric phase. The presence of a single peak indicates substantial solubility between the two polymers used.

Road Tests

The formulations shown in Table 1 were used to form the tread of Winter ICE Directional tyres (size 195/65R15). The tyres produced, which differed from each other only by the different composition of the tread mixture, were subjected to road tests on the Arctic Falls circuit (Sweden).

All the tests were conducted on tyres mounted on a Volkswagen Golf 1.6 automobile, on a rectangular area (about 20×200 m) with an asphalt road-bed and a mirror ice surface of about 2 cm thickness.

The following driving parameters were measured during the tests:

Braking: average stopping space;

Acceleration: average space required to cover the predetermined speed range;

Handling on ice: value, assigned by the tester, based on the average of the results measured in relation both to the time for completing the circuit and the road grip, and expressed as a handling index. The results are shown in Table 4.

TABLE 4

| | | Example | Example | Example | Example |
|---|---|---|---|---|---|
| | Reference | A (cfr.) | B (cfr) | C (cfr.) | D |
| Handling on | 100 | 100 | 85 | 104 | 108 |
| ice | | | | | |
| Braking (%) | 100 | 97 | 93 | 106 | 109 |
| Acceleration | 200 | 100 | 91.5 | 104 | 110 |
| (%) | | | | | |

Cfr. = comparison

From the data of Table 4 it is apparent that the use of SBRs of high Tg but soluble with the polybutadiene, so as to have only one maximum peak in the curve of tandelta against temperature, enables a substantial improvement to be obtained in all aspects of behaviour on ice.

1. A method for improving the grip of a tyre (1) on a snowy and/or icy road, said tyre comprising a belt structure (12) extending coaxially about a carcass structure (2), and a tread band (9) extending coaxially about the belt structure (12) and presenting a rolling surface (9a) arranged to enter into contact with the ground, which comprises forming said tread band with a base elastomeric material comprising at least 70 wt %, preferably at least 80 wt %, on the total weight of the elastomeric components, of a polymer mixture comprising:
(A) from 20 to 60 wt % of at least one styrene/1,3-butadiene copolymer having a content of styrene units from 10 to 25 wt %, and a content of vinyl units from 40 to 80 wt %; and
(B) from 40 to 80 wt % of at least one 1,3-butadiene homopolymer having a content of vinyl units lower than or equal to 15 wt %;
the quantities of (A) and (B) being expressed on the total weight of the polymer mixture;
wherein:
the copolymer (A) has a glass transition temperature (Tg) higher by at least 30° C. than the Tg of the homopolymer (B), and wherein
the mixture of the copolymer (A) with the homopolymer (B) shows a single glass transition peak having a maximum between −70° C. and 45° C.

2. A method as claimed in claim 1, wherein the copolymer (A) has a content of styrene units from 12 to 20 wt % and a content of vinyl units from 45 to 70 wt %.

3. A method as claimed in claim 1 or 2, wherein the homopolymer (B) has a content of vinyl units from 0.2 to 11 wt % and a content of 1,4-cis units from 92 to 99 wt %.

4. A method as claimed in any one of the preceding claims, wherein the homopolymer (B) has a content of vinyl units from 0.5 to 4 wt %.

5. A method as claimed in any one of the preceding claims, wherein the Tg of the copolymer (A) is higher than that of the homopolymer (B) by at least 40° C.

6. A method as claimed in any one of the preceding claims, wherein the Tg of the copolymer (A) is lower than or equal to −10° C. and the Tg of the homopolymer (B) is lower than or equal to −80° C.

7. A method as claimed in any one of the preceding claims, wherein the Tg of the copolymer (A) is from −50° C. to −30° C., while that of the homopolymer (B) is from −90° C. to −105° C.

8. A method as claimed in any one of the preceding claims, wherein the mixture of the copolymer (A) with the homopolymer (B) shows a single glass transition peak having a maximum between −65° C. and −55° C.

9. A method as claimed in any one of the preceding claims, wherein the copolymer (A) and the homopolymer (B) are present in the mixture in a quantity, respectively, from 25 to 50 wt % and from 50 to 75 wt %, on the total mixture weight.

10. A method as claimed in any one of the preceding claims, wherein the base elastomeric material comprises at least one elastomeric polymer (C), different from (A) and (B), in a quantity lower than or equal to 30 wt % on the total weight of the polymer material.

11. A method as claimed in the preceding claim, wherein the elastomeric polymer (C) is present in a quantity lower than or equal to 20 wt % on the total weight of the polymer material.

12. A method as claimed in claim 10 or 11, wherein the elastomeric polymer (C) is selected from natural rubber, polybutadiene, polyisoprene; polychloroprene, polynorbornene, isoprene-isobutene copolymers, possibly halogenated, butadiene-acrylonitrile copolymers, styrene-butadiene-isoprene terpolymers and ethylene-propylene-diene terpolymers.

13. A method as claimed in any one of claims from 10 to 12, wherein the polymer (C) is natural rubber.

14. A method as claimed in any one of the preceding claims, wherein the base elastomeric material comprises at least a reinforcing filler.

15. A method as claimed in the preceding claim, wherein the total quantity of the reinforcing filler varies from 50 to 100 phr.

16. A method as claimed in any one of claims from 10 to 12, wherein the reinforcing filler comprises at least one product selected from carbon black, alumina, silica, silico-aluminates, calcium carbonate, kaolin and the like or their mixtures.

17. A method as claimed in any one of claims from 14 to 16, wherein the reinforcing filler comprises silica in a quantity from 50 to 100 phr.

18. A method as claimed in any one of claims from 14 to 17, wherein the reinforcing filler comprises silica in a quantity from 60 to 70 phr.

19. A method as claimed in any one of claims from 14 to 18, wherein the reinforcing filler comprises carbon black in a quantity from 5 to 40 phr.

20. A method as claimed in the preceding claim, wherein the carbon black is in a quantity from 15 to 30 phr.

21. A method as claimed in any one of claims from 16 to 20, wherein there is added to the silica at least one coupling agent able to interact with it and bind it to the base elastomeric material.

22. A method as claimed in the preceding claim, wherein the coupling agent has the following structural formula:
(R)₃Si—CₙH₂ₙ—X
where:
the R groups, equal or different, are selected from: alky, alkoxy or aryloxy groups or halogen atoms, with the proviso that at least one of the R groups is an alkoxy or aryloxy group;
n is a whole number between 1 and 6;
X is a group selected from nitroso, mercapto, amino, epoxy, vinyl, imido, chloro, —(S)ₘ—CₙH₂ₙ—Si(R)₃, in which m is a whole number between 1 and 6 and n and the R groups are as hereinbefore defined.

23. A method as claimed in claim 21 or 22, wherein the coupling agent is bis(3-triethoxysilylpropyl)tetrasulphide.

24. A winter tyre (1) comprising a belt structure (12) extending coaxially about a carcass structure (2), and a tread band (9) extending coaxially about the belt structure (12) and presenting a rolling surface (9a) arranged to enter into contact with the ground, wherein said tread band comprises a base elastomeric material in accordance with any one of the preceding claims.
